(19) United States
(12) Patent Application Publication
(10) Pub. No.: US 2018/0243948 A1
(43) Pub. Date: Aug. 30, 2018

(54) 3-D PRINTED MOLD FOR INJECTION MOLDING

(71) Applicant: Stratasys Ltd., Rehovot (IL)

(72) Inventors: Eynat MATZNER, Adi (IL); Daniel DIKOVSKI, Ariel (IL); Ophira MELAMED, Shoham (IL); Lior ZONDER, Tel-Aviv (IL)

(21) Appl. No.: 15/756,990

(22) PCT Filed: Sep. 1, 2016
(86) PCT No.: PCT/IL2016/050961

§ 371 Date: Mar. 2, 2018

Related U.S. Application Data
(60) Provisional application No. 62/213,163, filed on Sep. 2, 2015.

(51) Int. Cl. B29C 33/38; B29C 64/165; B29C 45/26

(52) U.S. Cl. CPC B29C 33/3842; B29C 64/165; B33Y 10/00; B29C 45/2602; B29C 33/3828

(57) ABSTRACT

A multi-material mold and a method of constructing a multi-material mold for injection molding using additive manufacturing comprises defining a structure of the mold; and defining at least two sub-regions, associating the sub-regions with respective specific materials and printing the sub-regions with the specific material. The sub-regions may include an internal sub-region that allows dissipation of heat accumulating during use of the mold, where the specific material is heat conductive; an embedded heat sink sub-region for conducting heat away from the internal sub-region allowing dissipation, where the specific material is relatively non-conductive mold material embedded with lines or layers of relatively heat-conductive material; a sub-region resistant to abrasion, where the specific material is an abrasion-resistant polymer; a sub-region resistant to breaking under process conditions, where the specific material is a high toughness and high Tg polymer or a digital material and a sub-region of flexible material for sealing and releasing.

### FIELD AND BACKGROUND OF THE INVENTION

The present invention, in some embodiments thereof, relates to a 3D printed injection mold and methods of printing the same.

The injection molding (IM) process is widely used in industrial manufacturing of parts in all sizes, from small pieces to large components. Injection molded parts are produced by injection of a material, say thermoplastic or thermosetting, into a specifically designed mold, which results in a relatively cheap and fast mass production process. However, production of the mold itself is an expensive and time consuming one-off effort which is one of the major contributors to the final part production costs. Therefore, the injection molding process tends to be used only for parts for which large volume production is required. Small scale production generally does not make use of injection molding because of the constraints associated with the manufacture of the mold.

The IM process can be divided into four steps: plastification, injection, holding, and ejection. Polymer pellets are heated to form a melt which is injected into the cavity of a closed mold. The mold generally consists of at least two parts pressed together by a clamping unit. During the injection step, a pressure, which is counteracted by the clamping unit, is built up and maintained until the material in the cavity of the mold has solidified. Then, the mold opens, the molded plastic part is ejected and the mold is closed again for another production cycle. The mold is thus the centerpiece of the IM process. It is generally made of hardened steel, pre-hardened steel, aluminium, and/or beryllium-copper alloy to better sustain the high pressures and temperatures used during the whole process. The mold material is usually selected based on considerations such as long-term durability, cost and its heat dissipation capacity.

On the other hand, 3D printing or additive manufacturing (AM) approaches are gaining more and more attention in the industrial world. AM is a technology which has been developed and improved during the last two decades and enables the production of highly detailed 3D objects with complex shapes in a process wherein the building material is added layer-by-layer. However, limitations such as a slow printing speed and/or a lack of stability/quality of the final printed parts are the reasons why 3D printing technologies have been usually restricted to low volume production and has not been used in large scale fabrication processes of everyday goods.

In light of the above, the present inventors conceived the idea that 3D printing technologies, especially 3D inkjet printing technologies, could be very attractive in the field of injection molding since single customized molds having complex and detailed configurations could be easily and rapidly produced in this way. The shape of the molds can be easily designed in a CAD software and the molds can be produced in several hours and at low cost via an additive manufacturing technology (as opposed to standard metal molds which are very expensive and take weeks to be produced). Furthermore, fast printing of the mold via additive manufacturing would allow “trial-and-error” processes, whereby fine details of the mold can be optimized “on-site” to reach the best results (contrary to the standard process). Cheap and fast printing of the mold also enables applying the IM process to low volume production and/or production of prototype molds. However, IM molds are required to sustain high temperatures and high pressures and should be functional over a life time of about several thousands of injection cycles. In the standard IM process, the materials used for making a mold are metallic, especially stainless steel, which is not suitable for 3D printing. Metals offer several advantages when producing IM molds, especially due to their high heat conductivity (typically above 50 W/mK), excellent mechanical properties, smooth surfaces, and good stability.

In general, such a combination of properties cannot be matched by polymer materials employed in 3D printing technologies, especially those used in 3D inkjet technologies. Therefore there is a need to overcome the deficiencies of 3D printed molds, which are usually characterized by a low heat resistance, limited toughness, a low thermal conductivity, and a low abrasion resistance.

### SUMMARY OF THE INVENTION

The present embodiments relate to a multi-material mold that forms its own heat sink, and that overall provides the desired properties for use in injection molding. Some of the materials may themselves be composite materials, and heat conduction may be built in to the material structure.

According to an aspect of some embodiments of the present invention there is provided a method of constructing a multi-material mold using additive manufacturing comprising:

defining a structure of the mold;

within the structure defining at least two sub-regions, associating the sub-regions with respective specific materials and printing the sub-regions with the respective associated specific material; the sub-region and associated specific material being at least one member of the group consisting of:

a) an internal sub-region that allows dissipation of heat accumulating during use of the mold, the specific material being a heat conductive material;

b) an embedded heat sink sub-region for conducting heat away from the internal sub-region allowing dissipation, the specific material being a relatively non-conductive bulk mold material embedded with relatively heat-conductive material;

c) a sub-region resistant to abrasion, the specific material being an abrasion-resistant polymer;

d) a sub-region resistant to breaking under process conditions, the specific material being a high toughness or high Tg polymer;

e) a sub region of heat resisting material resistant to breakage, wherein the specific material comprises a combination of relatively heat conductive material and material being a high Tg or high HDT polymer;

f) a sub region for sealing or release, the specific material being a flexible material;

g) a sub region containing cooling tubes that are hollow and allow flow of a coolant; and

h) a sub region of a material being at least two of a-g.

In an embodiment, the specific materials comprise filled polymers, and each sub-region may comprise a polymer filled to bestow properties specific to the sub-region, based on a required performance.

In an embodiment, a heat conductivity of the relatively high heat conductive material is between 0.5-10 W/mK.

In an embodiment, the heat sink sub-region comprises a heat sink printed with polymeric ink, the polymeric ink forming conductive lines and layers designed to dissipate the heat from the internal mold surface.

In an embodiment, the heat conducting material comprises an ink filled with at least one carbon-based material.

In an embodiment, the carbon-based material comprises any of carbon nanotubes, graphene, nano-diamonds and carbon black.

In an embodiment, the heat conducting material comprises micron sized, sub-micron and/or nano particles.

In an embodiment, the micron sized, sub-micron and/or nano particles comprise any of metal nano etc-particles, ceramic nano etc particles, nano tubes, nano diamonds, and nano oxides.

In an embodiment, the heat conducting material comprises metal particles the metal particles comprising any of silver, copper, titanium and stainless steel.

In an embodiment, the heat conducting material comprises an ink filled with ceramic particles.

In an embodiment, the ceramic particles comprise any of: ceramic nano-particles, ceramic nano-tubes, and ceramic sub-micron particles.

In an embodiment, the ceramic particles comprise any of boron nitride, silicon nitride and alumina.

In an embodiment, the internal heat sink structure comprises a network of lines of thermally conductive material embedded in surrounding mold material.

An embodiment may comprise providing coolant tubes and pumping coolant through the coolant tubes.

An embodiment may comprise defining at least one sealing zone and printing the sealing zone with a flexible material.

An embodiment may further comprise defining a release zone to provide the mold with flexibility to release a formed product from the mold, and printing the release zone with a flexible material.

In an embodiment, the flexible material comprises any of a rubbery material, a rubbery material with an abrasion resistance filler and a rubbery material with a thermally conductive filler.

In an embodiment, the abrasion-resistant polymer comprises a polymer containing oxides.

In an embodiment, the oxides comprise at least any of silica, and alumina. In an embodiment, the abrasion resistant polymer comprises a fluorinated material.

The method may comprise determining a part of the mold suffering from most heat accumulation and printing at least one thermally conductive layer at the part, the thermally conductive layer leading to an array of cooling tubes within the mold.

The method may comprise printing an inner layer with a polymer being both an abrasion resistant and a heat conductive polymer, thereby to allow injection molding using abrasive polymers.

In an embodiment, the polymer being both an abrasion resistant and a heat conductive polymer is a polymer comprising both of a ceramic material filler and a carbon material filler.

The method may comprise printing a rubbery layer over a sealing area of the mold.

In an embodiment, the defining the structure of the mold comprises defining injection fills areas having a length substantially larger than a cross section. The method may further comprise providing the defined injection fill areas with a thermal conductivity being lower than a remainder of the mold.

According to a second aspect of the present embodiments there is provided a multi-material mold comprising:

a structure having at least two sub-regions, the sub-regions comprising respective specific materials; the sub-region and associated specific material being any of:

a) a sub-region resistant to heating during use of the mold, the specific material being a heat conductive polymer;

b) an external heat sink sub-region for conducting heat away from the internal sub-region allowing dissipation, the specific material being a relatively non-conductive mold material embedded with lines of relatively heat-conductive material;

c) a sub-region resistant to abrasion, the specific material being an abrasion-resistant polymer; and

d) a sub-region resistant to breaking under molding conditions, the specific material being a high toughness and high Tg polymer.

The internal sub-region susceptible to heating may comprise at least one thermally conductive layer.

In an embodiment, the heat conducting material comprises an ink filled with at least one carbon-based material.

The mold may comprise additional sealing zones printed with a flexible material.

The mold may comprise one or more release zones to provide the mold with flexibility to release a formed product from the mold, the release zone being printed with a flexible material.

The flexible material may be any of a rubbery material, a rubbery material with an abrasion resistance filler and a rubbery material with a thermally conductive filler.

The abrasion-resistant polymer may comprise a polymer containing oxides.

In an embodiment, the oxides comprise either or both of silica and alumina.

The abrasion resistant polymer may comprise a fluorinated material.

The mold may comprise a thermally conductive layer extending from a part of the mold suffering from most heat accumulation to embedded lines of thermally conductive material, thereby to conduct heat out of the mold.

The mold may comprise an inner layer with a polymer being both an abrasion resistant and a heat conductive polymer, thereby to allow injection molding using abrasive polymers.

In an embodiment, the polymer being both an abrasion resistant and a heat conductive polymer is a polymer comprising both of a ceramic material filler and a carbon material filler.

The mold may comprise a rubbery layer printed over a sealing area.

The structure of the mold may comprise injection fill areas having a length substantially larger than a cross section, the injection fill areas having a thermal conductivity being lower than a remainder of the mold.

According to a third aspect of the present invention there is provided a mold for use in injection molding, comprising additive layers of material including heat conducting material, and wherein the heat conducting material is arranged in layers to form a heat sink within the mold.

According to a fourth aspect of the present invention the invention provides a mold that has been constructed using the above-described method, in particular a multi material mold printed by ink jet 3D printing of polymers, wherein the polymers comprise polymerizable ink jet printable inks, at least one of the inks being enhanced with a heat conductive filler to form heat conductive layers in the mold.

In an embodiment, the heat conductive filler comprises boron nitride.

According to a fifth aspect of the present invention there is provided a method of constructing a multi-material mold using additive manufacturing comprising:

defining a structure of the mold;

within the structure defining a heat flow region;

printing the heat flow region using a material comprising at least 5% boron nitride.

According to a sixth aspect of the present invention there is provided a mold for use in injection molding, the mold comprising a plurality of materials, at least one of the plurality of materials comprising at least 5% boron nitride.

According to a seventh aspect of the present invention there is provided a method of producing a multi material mold comprising:

providing voxel level control of a mixture of polymerizable materials to create a digital material comprising different voxels with respectively different high toughness and high HDT; and
digitally printing each voxel using ink jet printing thereby forming said digital material.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flow chart illustrating a process for designing and printing a mold using additive manufacturing and the kinds of materials available for additive manufacturing, according to embodiments of the present invention;

FIG. 2 is a simplified schematic diagram of a mold manufactured according to the process of FIG. 1;

FIG. 3 is a graph showing effects of different materials on thermal conductivity, against a control indicated by DABS; and

FIG. 4 is a graph of percentage of Boron Nitride against thermal conductivity.

### DESCRIPTION OF SPECIFIC EMBODIMENTS OF THE INVENTION

The present invention, in some embodiments thereof, relates to a 3D printed injection mold and a method of printing the same. A multi-material mold, produced for example by ink jet 3D printing, has materials whose structure and combination may provide heat-sink and other desired properties. Some of the materials may themselves be composite materials, and heat conduction may be built in to the material structure. In some cases the multi-material mold may even improve the mold performance in comparison to the standard steel mold.

The design of the mold and the materials distribution inside the mold may depend on the mold structure, heat distribution, and stress and strain distribution, both of which may be calculated using software, from the structural design, angles and fine features. Software such as “Mold flow” that calculates the behavior of the injected material, including temperatures and forces within the mold, may be used.

The multi material mold may consist of one or more of the following kinds of polymers:

1. A heat conductive polymer in areas that become heated in the mold. Selective use of heat conductive polymer/material, typically a filled polymer, may allow for control of heat conductivity. The expected heat conductivity may be raised from around 0.2 W/mK for standard unimproved ink and polymer to 0.5-10 W/mK for the heat conductive ink and polymer. The area of the mold closest to the injection material, typically that area under the most heat stress during molding, may be constructed of a complete layer of heat conducting polymer. Areas further away may have heat conductive polymer embedded in surrounding bulk material, to form heat conduction paths to conduct heat away from the interior of the mold and thus provide the mold with a built-in heat sink;

2. An abrasion resistant polymer in areas susceptible to abrasion;

3. A high toughness and high Tg polymer in areas susceptible to breaking;

4. A high HDT polymer;

5. A polymer printed with internal tubes that can pass coolant. Effective cooling may thus be provided based on the tubes introduced into the structure, a feature which is possible in 3D printing. The tubes may meet with the heat conduction layers; and

6. Use of flexible materials to provide good sealing and release properties. As well as sealing prior to injection, flexible materials allow for removing the formed product from the mold.

Regions within the mold may contain combinations of the above materials. Thus a region that is required both to be structurally resilient and conduct heat may have a bulk of structurally resilient polymer interspersed with layers of heat conducting polymer.

The above properties may be achieved using filled inks. For example heat conductivity can be achieved using inks filled with carbon based materials. Such materials may be for example CNT, graphene, nano-diamonds and carbon black.

Alternatively or additionally, heat conductivity can be achieved using inks containing metal nano-particles. The metals may be for example silver, copper, titanium or stainless steel.

Heat conductivity may also be achieved using inks filled with ceramic nano particles, nano tubes and micron and sub-micron particles. The nano particles and micron and sub-micron particles may be boron nitride, silicon nitride, alumina and the like.

The heat conductive material may be filled with a mixture of fillers, such as metals, ceramic and carbon fillers at the same time, in different ratios and compositions.

To improve abrasion resistance, improved surface qualities including surface smoothness and sealing ability, the inks may be polymers filled with oxides such as silica, alumina, and fluorinated materials, as well as with diamond. For better sealing and part extraction the inks may use rubbery materials, or may be rubbery materials filled with abrasion resistance fillers and thermally conductive fillers. Part extraction may also be assisted by suitable ink modification for easier part release. For example, the ink may be modified with a PTFE type substance to reduce friction. Alternatively one may use silicone or Teflon spray for mold release.

The distribution of the materials within the mold may depend on the mold structure and the heat and stress distribution within the mold. Abrasion resistance may be needed at the interior surfaces of the mold but not necessarily deep within, whereas heat conduction may be needed at the internal surfaces, with heat conduction paths deep within and towards the external surfaces. Structurally strong materials may be arranged to form a strong framework so that the mold can withstand the necessary pressures and the overall material distribution may take into account the fine features of the mold and sharp angles.

The heat sink construction may consist of a thermally conductive layer in the inner layers of the mold that suffer from most heat accumulation and thermal conductive printed lines may lead from the surface by embedded lines or layers to cooling tubes printed into the structure of the mold. Such cooling tubes may be used for water or air cooling, or may use metal inserts for cooling.

The conductive printed lines and layers may transfer the heat from the internal part of the mold to the cooling area and increase the cooling rate of the mold.

The abrasion resistant material may be used when abrasive polymers are injected such as filled polymers. In such a case the inner layer can be filled with both thermally conductive and abrasion resistant fillers such as ceramic and diamond fillers.

The mold design may take into account the need for flow of the thermoplastic within the mold before setting, and the design may involve fine tuning the thermal conductivity to achieve the right cooling effect considering the melt flow of the injected material and the part geometry. Thus by having lower thermal conductivity in long thin areas of the mold it is possible to keep the material flowing for a longer time and ensure good and even filling of the mold by the thermoplastic material.

Herein, the following definitions may apply:

High toughness/impact: at least 90 J/m2

High Tg: at least 65° C.

High HDT: at least 85° C.

For a better understanding of the present invention and to show how the same may be carried into effect, reference is now made to specific embodiments which are given by way of example.

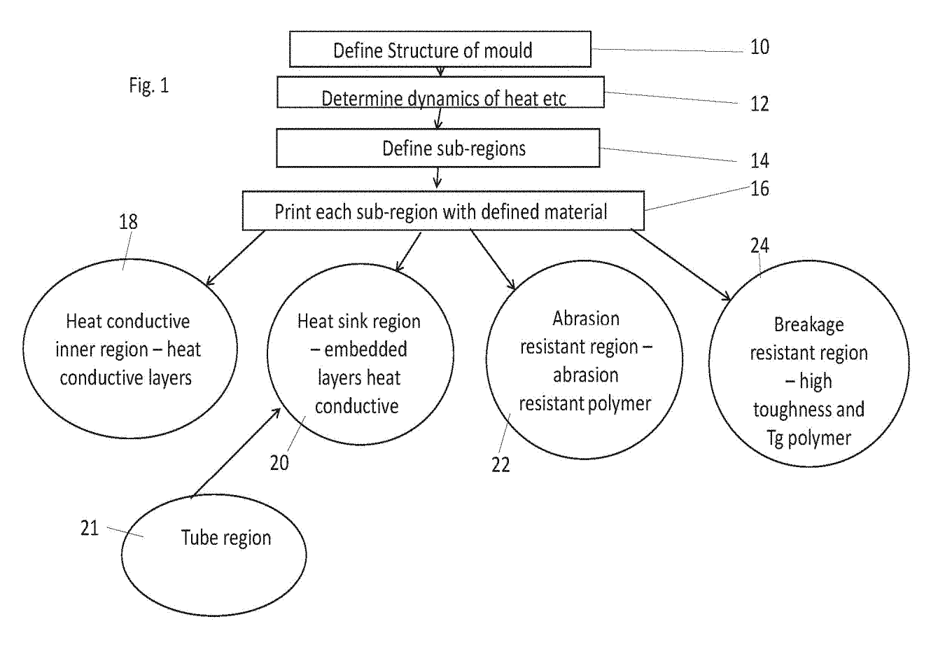

Reference is now made to FIG. 1, which is a simplified flow chart that illustrates a method of designing and constructing a multi-material mold using additive manufacturing, otherwise known as 3D printing.

Box 10 indicates defining a structure of the mold, which is generally based on the part to be molded. As additive manufacturing generally uses polymers rather than metal, attention has to be paid to strength and heat conduction. Firstly, as regards strength, the mold has to be made strong enough to contain the material being injected at the injection pressure. Furthermore there are particular regions such as corner regions which are particularly susceptible to failure as they experience greater pressure. The injected material is not just under pressure but also hot, and heat passage is not smooth but tends to concentrate in certain areas in the mold. Box 12 relates to calculating the dynamics of mechanical pressure, heat flow etc. and how the stresses interact with the shape of the mold, given the distribution of edges of given angles etc. Box 14 relates to defining sub-regions within the mold that may deal with the dynamics.

The sub-regions are defined specifically for the different dynamics and relate to localizing selected materials in the sub-regions to deal with the dynamics. Not all of the sub-regions may be needed in any given mold, and some sub-regions may have multiple tasks. Not all of the sub-regions have to do with the heat and pressure dynamics. Some of the sub-regions may for example have to do with sealing and subsequent release of the mold.

Within the structure of the mold, two or more different sub-regions are defined to provide different conditions for handling the dynamics during the injection molding procedure. Each sub-region contains specific materials that enable the sub-region to handle the conditions of injection molding. Then in box 16 what remains is to print the mold, using the materials for each sub-region.

The following defines an open list (meaning not necessarily complete) of sub-regions that may be included in any particular mold.

One possible sub region 18 is an internal sub-region, ‘internal’ meaning in the region of the internal face of the mold that receives the injected material. Such a sub-region allows dissipation of heat from the injection process that accumulates during use of the mold, because the injected material is either hot or under pressure. The specific material is a heat conductive material and is typically provided as a layer within the bulk of the mold. Typically, the inner face of the mold facing the injected material comprises a layer of heat conducting polymer.

A further sub-region 20 is a connective heat sink sub-region that connects to the internal sub-region and the internal heat conducting layers and provides one or more paths conducting heat away from the internal sub-region, allowing dissipation of the heat from the inside of the mold to the outside of the mold. Here the specific material is a relatively non-conductive mold material that provides a bulk, the bulk being embedded with lines or layers of relatively heat-conductive material. The lines or layers may be provided at a selected density as needed for the amount of heat needing to be dissipated. The connective sub-region may provide a heat sink built into the structure of the mold. In addition, if greater heat conduction is needed, then additional hollow tubes may be printed into the structure of the bulk and connect with the layers of the connective sub-region, to form a tube region 21. The hollow tubes may have coolant liquid pumped through them to collect heat from the layers and thus further enhance the power of the heat sink. The hollow tubes may connect to an external pump including cooling fins or even cooling fans and if necessary to refrigerating technology. Thus the tube region is typically external.

Sub-region 22 is typically internal and is constructed to be resistant to abrasion. Certain molding materials may be particularly abrasive, and some parts of the mold, particularly at sharp corners, may be particularly susceptible to abrasion. When either or both of these apply then an abrasion-resistant sub-region is defined, and the specific material is an abrasion-resistant polymer, as will be discussed in greater detail below. It is noted that abrasion resistance and heat conduction are not mutually exclusive and the different sub-regions can overlap, with layers of abrasion resistant material and of heat conductive material being adjacent to each other.

Sub-region 24 is a sub-region resistant to breaking under process conditions. Some molding processes may use particularly high pressure and some mold shapes may contain regions that are particularly vulnerable to strain and cracking. In either case a breakage resistant sub-region is defined where necessary and the specific material used may be a high toughness and high Tg polymer, or an ink filled with a filler provided for high toughness and/or high Tg or a digital material.

The heat conducting material may be printed as thermally conductive layers within a bulk mold material. The heat conducting material may be provided as an ink filled with one or more carbon-based materials, such as carbon nanotubes, graphene, nano-diamonds and carbon black. The ink is printed in the normal way to form layers within the mold. Use of nanoparticles is not restricted to carbon, and metal nano-particles may be used as well or in their stead. The metal nano particles may include silver, copper, titanium and stainless steel or any other suitable metal nano-particle. As well as nano-particles, micron and sub-micron particles may be used.

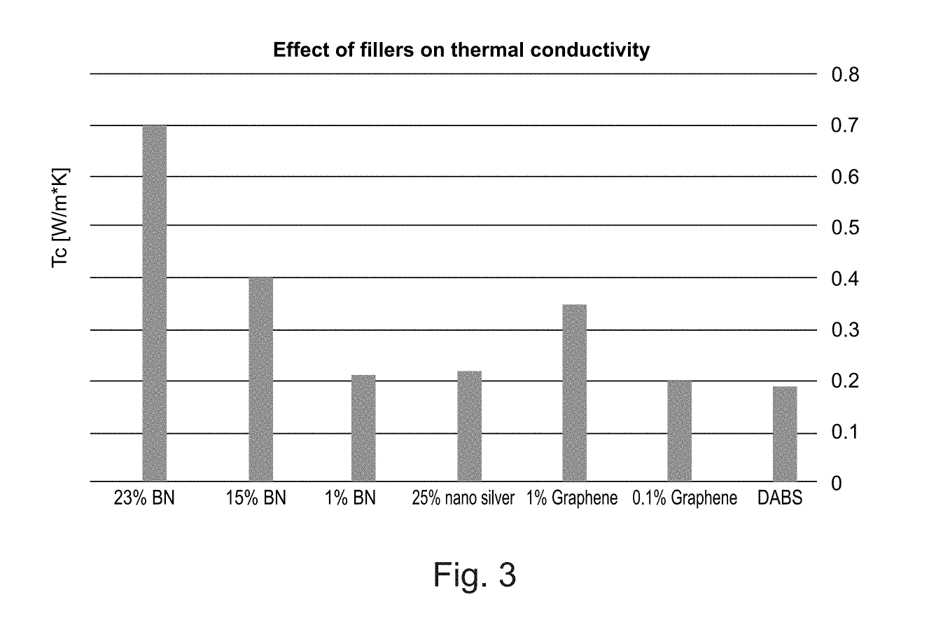

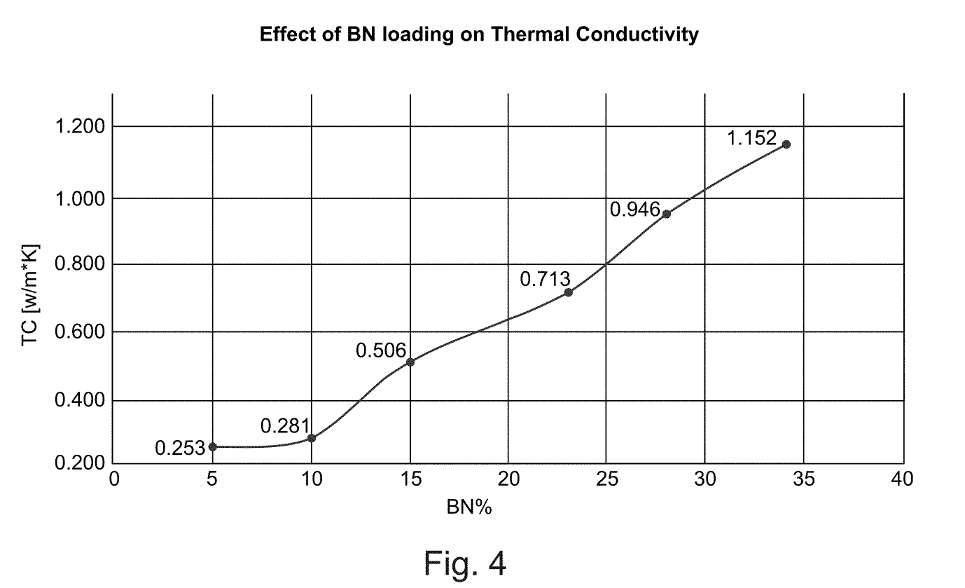

As a further alternative, the heat conducting material may comprise an ink filled with ceramic particles. Suitable ceramic particles may include ceramic micron sized, sub-micron and/or nano-particles, such as ceramic nano-tubes, and ceramic sub-micron particles. Materials for use as ceramic particles of suitable size may include boron nitride, silicon nitride and alumina. Boron nitride is discussed in greater detail with reference to FIGS. 3 and 4 below.

Particle sizes of the fillers preferably may for example not exceed a few microns, preferably less than 5 microns, to enable jetting by ink jet heads.

The heat conductive material may be printed in the form of conductive traces or lines within the mold bulk from the hot internal surface of the mold to the outside or to the cooling areas to allow heat dissipation from the inside of the mold. The advantages of dissipating the heat are:

1. The polymer material is kept intact for longer as it is not exposed to very high temperatures for a very long time;

2. The effective cooling allows for faster cooling of the injected material and for quicker part ejection; and

3. The heat is more evenly distributed within the mold and does not accumulate in specific sensitive areas, thus also helping to extend the life time of the mold.

As discussed, the method may comprise providing coolant tubes, meaning tubes through which coolant may be pumped during molding operations. The cooling tubes may be printed with a conductive or non-conductive material.

Before injection, the mold may be sealed, and a sealing zone may be defined and printed. The sealing zone may use a flexible material to improve the sealing capabilities. The injected material sets to form the molded product and at some stage has to be extracted from the mold. The mold may therefore be defined with a release zone to provide the mold with flexibility to release the molded product without having to damage the mold. The release zone is typically printed with a flexible material.

For both the sealing and release zones, a suitable flexible material may include one or more of a rubbery material per se, a rubbery material with an abrasion resistance filler and a rubbery material with a thermally conductive filler. The latter two allow for the sealing or release zones to be combined with abrasion resistant or heat conducting sub-zones. The rubbery material may be printed over the sealing area or along the flexible zone.

Returning to the abrasion resistant zone 22, and an abrasion-resistant polymer that includes a polymer containing oxides may be used. The oxides may include for example silica, and alumina.

Alternatively or additionally the abrasion resistant polymer comprises a fluorinated material.

Using the present embodiments, anyone wanting to print a mold may determine where in the mold there are likely to be high levels of heat accumulation. The mold may be printed to include one or more thermally conductive layers at the determined locations. The thermally conductive layers may lead to an array of embedded heat-conducting lines also within the mold to conduct heat from the layers.

Likewise the analysis may indicate higher and lower areas of heat accumulation within the mold, and different densities of thermally conductive layers may be provided accordingly.

As mentioned, abrasion resistance and heat flow may be combined, and the mold may be printed with layers that use a polymer which is both an abrasion resistant and a heat conductive polymer. An example of a polymer being both an abrasion resistant and a heat conductive polymer is a polymer comprising both of a ceramic material filler and a carbon material filler. The use of abrasion resistant regions enables printed molds to be extended to molding using abrasive polymers as the injection material.

As part of the construction of the mold there may be areas which are long and thin and areas which are more bulky. The injected material needs to flow to fill out the thin areas and therefore it is problematic if the material sets before it has finished flowing through the thin area since this prevents filling out the entire shape. Thus the mold may be designed so that the walls of such a thin area, meaning any part of the mold having a length substantially larger than a corresponding cross section have a thermal conductivity which is kept relatively low, so as to allow for filling out of the mold. That is to say the thermal conductivity must be high enough so that the mold does not get damaged but must also be low enough not to cool the plastic until flow into the mold is complete.

Another group of materials that can be used are the so-called digital materials. A digital material is the result of combining two or three PolyJet photopolymers in specific concentrations and microstructures to create a composite material with hybrid characteristics. For example a digital material may combine a translucent Rubber-like material known as Tango Plus with rigid opaque materials known as Vero Magenta and Vero Yellow. The resulting hue varies from yellow to magenta with a range of oranges in between, while the color intensity and opacity fade as the flexibility increases.

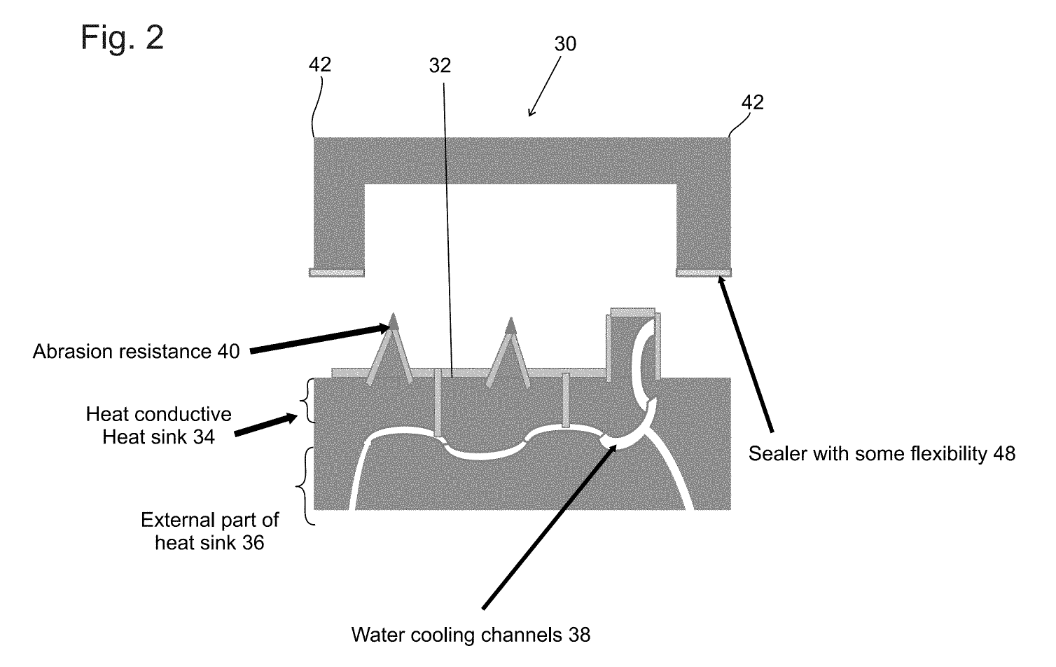

Reference is now made to FIG. 2 which is a schematic diagram, illustrating a multi-material mold manufactured by additive manufacturing. Mold 30 has a structure that includes sub-regions to form a compound mold. The sub-regions each comprise specific materials to give them a desired property. The various sub-regions are as described above. The internal heat resistant region may comprise a layer 32 at the molding surface, and the layer may be printed using a heat conductive polymer. Examples of suitable materials are discussed above. Region 34 provides a heat sink of heat conductive channels embedded in the surrounding mold material. The heat channels provide a path to remove heat from the layer 32. An external part 36 of the heat sink sub-region may contain cooling channels 38, through which water or other cooling fluid can be pumped.

A sub-region resistant to abrasion 40 may be provided at locations in the mold particularly susceptible to abrasion. In the example shown the abrasion region is located at sharp points in the mold. The abrasion resistant region may use an abrasion-resistant polymer.

A sub-region resistant to breaking under molding conditions is provided around sharp corner 42 to prevent breakage, the region using a high toughness and high Tg polymer or a digital material.

A sealing zone is provided where top 44 and bottom 46 mold parts come together. The sealing zone contains one or more layers of rubbery material to form sealer 48, as discussed above.

Reference is now made to FIG. 3, which is a bar chart showing effects of different materials on thermal conductivity, against a control indicated by DABS. Any material whose bar exceeds the control is potentially of interest, although other effects of the material may also be taken into account. Thus 1% graphene has very good thermal conductivity but may render the material brittle and has low reactivity to UV, making it difficult to cure. Boron nitride at 15% and even more so at 23% has good thermal conductivity. At 1%, Boron Nitride just beats the control. 25% nano silver also just beats the control.

TABLE 1
Properties of five different fillers

| | Max loading | Max TC | | response to |
|---|---|---|---|---|
| Filler | (Wt %) | (W/mK) | Viscosity cps | UV curing |
| Graphene | 5 | 0.5 | / | low |
| Silicon Nitride | 15 | 0.3 | 1000 at 25C | ok |
| Nano Silver | 25 | 0.23 | / | ok |
| Boron Nitride | 15 | 0.45 | 45 at 75C | ok |
| 15% | | | | |
| Boron Nitride | 32 | 1.1 | / | ok |
| 32% | | | | |

Reference is now made to FIG. 4, which is a graph of percentage of Boron Nitride loading against thermal conductivity. The graph is relatively flat below 10% and barely beats the control but then rises steadily up to 34% where the graph ends.

From FIG. 4 it may be concluded that adding Boron Nitride in different concentrations may affect the thermal conductivity. The concentration used may be at least 5% and may take any value between 5% and 34% or beyond 34%. In particular, 10%, 15%, 20%, 25%, and 30% and in-between values may be considered.

It is expected that during the life of a patent maturing from this application many relevant methods and materials for additive manufacturing and for injection molding will be developed and the scope of the terms used herein are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment, and the above description is to be construed as if this combination were explicitly written. Conversely, various features of the invention, which are, for brevity, described in the context of a single embodiment, may also be provided separately or in any suitable subcombination or as suitable in any other described embodiment of the invention, and the above description is to be construed as if these separate embodiments were explicitly written. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of constructing a multi-material mold using additive manufacturing comprising:
defining a structure of said mold;
within said structure defining at least two sub-regions;
associating said sub-regions with respective specific materials; and
printing said sub-regions with said respective associated specific material;
wherein a first of said two sub-regions comprises an internal sub-region that allows dissipation of heat accumulating during use of the mold, the associated first sub-region specific material being a heat conductive material, and the second of said two sub-regions comprises an embedded heat sink sub-region for conducting heat away from said internal sub-region allowing dissipation, and an associated second sub-region specific material, said second sub-region specific material being a relatively non-conductive bulk mold material embedded with relatively high heat-conductive material, and
wherein said heat sink sub-region comprises a heat sink printed with polymeric ink, said polymeric ink forming conductive lines and layers designed to dissipate the heat from the internal mold surface.

2-3. (canceled)

4. The method of claim 1, wherein said sub regions and associated specific materials further comprises at least one member of the group consisting of:
a) a sub-region resistant to abrasion, said specific material being an abrasion-resistant polymer;
b) a sub-region resistant to breaking under process conditions, said specific material being a high toughness or high Tg polymer;
c) a sub region of heat resisting material resistant to breakage, wherein said specific material comprises a combination of relatively heat conductive material and material being a high Tg or high HDT polymer;
d) a sub region for sealing or release, said specific material being a flexible material; and
e) a sub region containing cooling tubes that are hollow and allow flow of a coolant.

5. The method of claim 1, wherein said heat conductive material comprises one member of the group consisting of: an ink filled with at least one carbon-based material, an ink filled with carbon nanotubes, an ink filled with graphene, an ink filled with nano-diamonds, an ink filled with carbon black, micron sized particles, sub-micron sized particles, nano-particles, metal particles, silver particles, copper particles, titanium particles, stainless steel particles, an ink filled with ceramic particles, an ink filled with ceramic nano-particles, an ink filled with ceramic nano-tubes, an ink filled with ceramic sub-micron particles, an ink filled with boron nitride, an ink filled with silicon nitride and an ink filled with alumina.

6-12. (canceled)

13. The method of claim 1, wherein said internal heat sink comprises a network of lines of thermally conductive material embedded in surrounding mold material, the method further comprising providing coolant tubes and pumping coolant through said coolant tubes.

14. (canceled)

15. The method of claim 1, further comprising defining at least one sealing zone and printing said sealing zone with a flexible material.

16. The method of claim 1, further comprising defining a release zone to provide said mold with flexibility to release a formed product from the mold, and printing said release zone with a flexible material.

17. The method of claim 15, wherein the flexible material comprises one member of the group consisting of a rubbery material, a rubbery material with an abrasion resistance filler and a rubbery material with a thermally conductive filler.

18. The method of claim 4, wherein said abrasion-resistant polymer comprises a polymer containing oxides, or a polymer containing silica or a polymer containing alumina, or a fluorinated material.

19-20. (canceled)

21. The method of claim 1, comprising determining a part of said mold suffering from most heat accumulation and printing at least one thermally conductive layer at said part, said thermally conductive layer leading to an array of cooling tubes within said mold.

22. The method of claim 1, comprising printing an inner layer with a polymer being both an abrasion resistant and a heat conductive polymer, thereby to allow injection molding using abrasive polymers.

23. The method of claim 22, wherein said polymer being both an abrasion resistant and a heat conductive polymer is a polymer comprising both of a ceramic material filler and a carbon material filler.

24. The method of claim 1, further comprising printing a rubbery layer over a sealing area of said mold.

25. The method of claim 1, wherein said defining said structure of said mold comprises defining injection fill areas having a length substantially larger than a cross section, the method comprising providing said defined injection fill areas with a thermal conductivity being lower than a remainder of said mold.

26. A multi-material mold comprising:
a structure having at least two sub-regions, said sub-regions comprising respective specific materials; one of said at least two sub-regions comprising an internal sub-region that allows dissipation of heat accumulating during use of the mold, and associated with a first specific material being a heat conductive material,
and the other of said at least two sub-regions comprising an embedded heat sink sub-region for conducting heat away from said internal sub-region allowing dissipation, and associated with a second specific material being a relatively non-conductive bulk mold material embedded with lines of relatively heat-conductive material, said embedded heat sink sub-region comprising a heat sink printed with polymeric ink, said polymeric ink forming conductive lines and layers designed to dissipate the heat from the internal mold surface.

27. (canceled)

28. The mold of claim 26, wherein said heat conductive material comprises at least one member of the group consisting of: an ink filled with at least one carbon-based material, an ink filled with carbon nanotubes, an ink filled with graphene, an ink filled with nano-diamonds, an ink filled with carbon black, micron sized particles, sub-micron sized particles, nano-particles, metal particles, silver particles, copper particles, titanium particles, stainless steel particles, an ink filled with ceramic particles, an ink filled with ceramic nano-particles, an ink filled with ceramic nano-tubes, an ink filled with ceramic sub-micron particles, an ink filled with boron nitride, an ink filled with silicon nitride and an ink filled with alumina.

29-35. (canceled)

36. The mold of claim 26, wherein said internal heat sink sub-region comprises a network of embedded lines or layers, or further comprises hollow tubes and a coolant pump for pumping coolant through said hollow tubes.

37. (canceled)

38. The mold of claim 26, further comprising at least one sealing zone printed with a flexible material.

39. The mold of claim 26, further comprising a release zone to provide said mold with flexibility to release a formed product from the mold, said release zone being printed with a flexible material.

40. The mold of claim 38, wherein the flexible material comprises one member of the group consisting of a rubbery material, a rubbery material with an abrasion resistance filler, a rubbery material with a thermally conductive filler, an abrasion resistant polymer containing oxides, an abrasion resistant polymer containing silica, an abrasion resistant polymer containing alumina and an abrasion resistant polymer containing a fluorinated material.

41-43. (canceled)

44. The mold of claim 26, comprising a thermally conductive layer extending from a part of said mold suffering from most heat accumulation to embedded lines of thermally conductive material, thereby to conduct heat out of said mold.

45. The mold of claim 26, comprising an inner layer with a polymer being both an abrasion resistant and a heat conductive polymer, or a polymer being both a ceramic material filler and a carbon material filler, thereby to allow injection molding using abrasive polymers.

46. (canceled)

47. The mold of claim 26, further comprising a printed rubbery layer located over a sealing area of said mold.

48. The mold of claim 26, wherein said structure of said mold comprises injection fill areas having a length substantially larger than a cross section, said injection fill areas having a thermal conductivity being lower than a remainder of said mold.

49-55. (canceled)

56. The mold of claim 26, comprising a further sub group and associated specific material, the associated specific material being one member of the group consisting of:
a) a sub-region resistant to heating during use of the mold, said specific material being a heat conductive polymer;
b) a sub-region resistant to abrasion, said specific material being an abrasion-resistant polymer; and
c) a sub-region resistant to breaking under molding conditions, said specific material being a high toughness and high Tg polymer.
